(19) United States
(12) Patent Application Publication
(10) Pub. No.: US 2013/0258962 A1
(43) Pub. Date: Oct. 3, 2013

(54) BASE STATION APPARATUS, MOBILE STATION APPARATUS, WIRELESS TRANSMISSION METHOD, AND WIRELESS RECEPTION METHOD

(71) Applicant: FUJITSU LIMITED, Kawasaki-shi (JP)

(72) Inventor: Yoshiyuki OOTA, Yokohama (JP)

(73) Assignee: FUJITSU LIMITED, Kawasaki-shi (JP)

(21) Appl. No.: 13/801,742

(22) Filed: Mar. 13, 2013

(30) Foreign Application Priority Data
Mar. 30, 2012 (JP) 2012-083182

(51) Int. Cl. H04W 72/10

(52) U.S. Cl. CPC H04W 72/10
USPC 370/329

(57) ABSTRACT

A base station apparatus operable to communicate by using any of a plurality of frequency bands, each of which includes a plurality of unit bands, the apparatus includes a determiner that determines a unit band to which to assign data, according to a priority of the data, to a maximum data transfer rate of the data, to a distance between the base station apparatus and a mobile station apparatus to which to send the data, or to a number or tried receptions of a preamble signal that has been sent from the mobile station apparatus through a random access channel, and a transmitter that sends the data by using the determined unit band.

### CROSS-REFERENCE TO RELATED APPLICATION(S)

This application is based upon and claims the benefit of priority of the prior Japanese Patent Application No. 2012-083182, filed on Mar. 30, 2012, the entire contents of which are incorporated herein by reference.

### FIELD

The embodiments discussed herein are related to a base station apparatus, a mobile station apparatus, a wireless transmission method, and a wireless reception method.

### BACKGROUND

The Third Generation Partnership Project Long Term Evolution-Advanced (3GPP-LTE-A) enables one base station apparatus (simply referred to below as the base station) to use a plurality of mutually different frequency bands in communication with a mobile station apparatus (simply referred to below as the mobile station). In the 3GPP-LTE-A, the basic unit (referred to below as the unit band) of communication bands is called a component carrier (CC). Each of the plurality of frequency bands that the base station can use includes a polarity of CCs. When sending data to a mobile station, the base station assigns data to any one CC in any one frequency band.

However, specific considerations have not been made to appropriately assign data to CCs.

Japanese National Publication of International Patent Application Nos. 2011-501887 and 2011-514746 and International Publication Pamphlet No. WO 2008/108222 are examples of related art.

### SUMMARY

According to an aspect of the invention, a base station apparatus operable to communicate by using any of a plurality of frequency bands, each of which includes a plurality of unit bands, the apparatus includes, a determiner that determines a unit band to which to assign data, according to a priority of the data, to a maximum data transfer rate of the data, to a distance between the base station apparatus and a mobile station apparatus to which to send the data, or to a number or tried receptions of a preamble signal that has been sent from the mobile station apparatus through a random access channel, and a transmitter that sends the data by using the determined unit band.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of frequency bands used in data signal transmission;

FIG. 2 is a block diagram that illustrates an example of the structure of a base station in a first embodiment;

FIG. 3 illustrates processing executed by an assignment CC determiner in the first embodiment;

FIG. 4 illustrates a specific example of assignment in the first embodiment;

FIG. 5 is a flowchart that illustrates operation performed by the base station in the first embodiment;

FIG. 6 is a block diagram that illustrates an example of the structure of a base station in a second embodiment;

FIG. 7 illustrates processing executed by an assignment CC determiner in the second embodiment;

FIG. 8 illustrates a specific example of assignment in the second embodiment;

FIG. 9 is a flowchart that illustrates operation performed by the base station in the second embodiment;

FIG. 10 is a block diagram that illustrates an example of the structure of a base station in a third embodiment;

FIG. 11 illustrates processing executed by an assignment CC determiner in the third embodiment;

FIG. 12 illustrates a specific example of assignment in the third embodiment;

FIG. 13 is a flowchart that illustrates operation performed by the base station in the third embodiment;

FIG. 14 is a block diagram that illustrates an example of the structure of a base station in a fourth embodiment;

FIG. 15 is a flowchart that illustrates operation performed by the base station in the fourth embodiment;

FIG. 16 is a block diagram that illustrates an example of the structure of a mobile station in a fifth embodiment;

FIG. 17 illustrates an example of the hardware structure of the base stations; and

FIG. 18 illustrates an example of the hardware structure of the mobile station.

### DESCRIPTION OF EMBODIMENTS

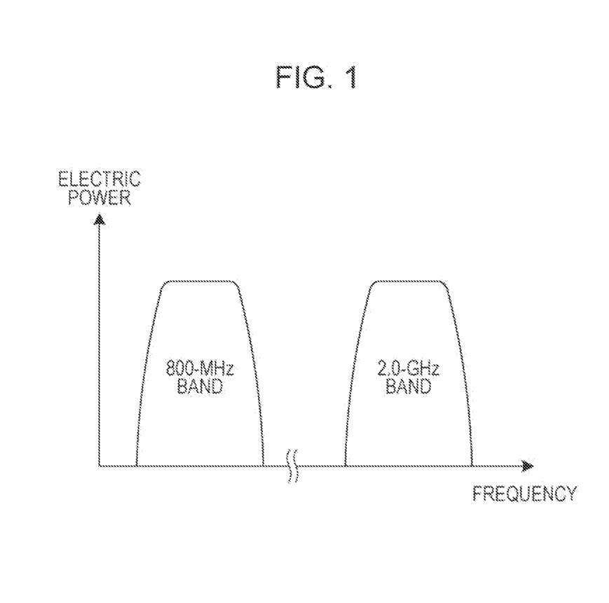

FIG. 1 illustrates an example of frequency bands used in data signal transmission. As illustrated in FIG. 1, the 3GPP-LTE-A enables a base station to use a plurality of frequency bands in communication with a mobile station. For example, the base station can use a plurality of frequency bands including a 700-MHz band, 800-MHz band, 900-MHz band, 1.5-GHz band, 1.7-GHz band, and 2.0-GHz band. In FIG. 1, the 800-MHz band is illustrated as an example of a low-frequency band and the 2.0-GHz band is illustrated as an example of a high-frequency band. In the technology disclosed in this description, each of a plurality of frequency bands that the base station can use is classified as a high frequency band or a low frequency band. For example, the 700-MHz band, 800-MHz band, and 900-MHz band are classified as low-frequency bands, and 1.5-GHz band, 1.7-GHz band, and 2.0-GHz band are classified as high-frequency bands.

Radio signals in low-frequency bands are more diffractive than in high-frequency bands. Even if there is an obstacle, therefore, radio signals in low-frequency bands are easy to arrive; they also easily enter the interior of a room. By contrast, radio signals in high-frequency bands tend to propagate linearly, so if there is an obstacle, they are difficult to arrive. Accordingly, in an environment in which there is an obstacle, radio signals in low-frequency bands are more likely arrive at a long distance point than in high-frequency bands.

Noting that radio signals in low-frequency bands of a plurality of frequency bands that a base station can use are easier to propagate than in high-frequency as described above, the inventor devised embodiments described below.

Embodiments of the base station, mobile station, wireless transmission method, and wireless reception method disclosed in this application will be described in detail with reference to the drawings. The base station, mobile station, wireless transmission method, and wireless reception method disclosed in this application are not restricted by the embodiments described below. In the embodiments below, elements having like structures will be denoted by like reference numerals, and repeated descriptions will be omitted.

### First Embodiment

Structure of the Base Station 10

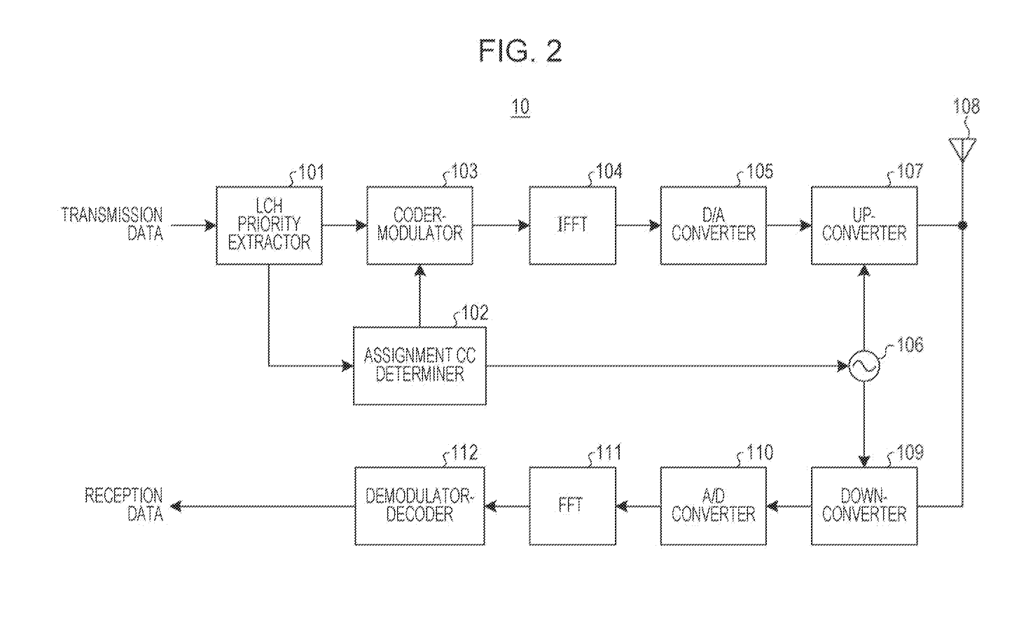

FIG. 2 is a block diagram that illustrates an example of the structure of the base station 10 in the first embodiment. The base station 10 in FIG. 2 includes a logical channel (LCH) priority extractor 101, an assignment component carrier (CC) determiner 102, a coder-modulator 103, an inverse fast Fourier transformer (IFFT) 104, a digital-to-analog (D/A) converter 105, a local signal generator 106, an up-converter 107, an antenna 108, a down-converter 109, an analog-to-digital (A/D) converter 110, a fast Fourier transformer (FFT) 111, and a demodulator-decoder 112.

The LCH priority extractor 101 extracts an LCH priority added to transmission data, outputs the extracted LCH priority to the assignment CC determiner 102, and outputs the transmission data to the coder-modulator 103. The LCH priority indicates a priority of the transmission data. An LCH priority is set for each transmission data item by a high-end layer according to, for example, the data's importance, urgency, nature of real time, quality of service (QoS), or total amount of data, and is added to the transmission data.

The assignment CC determiner 102 determines CCs to which transmission data is to be assigned (this type of CCs will be referred to below as assignment CCs) according to the LCH priority that the assignment CC determiner 102 has received from the LCH priority extractor 101, and controls the frequency of the local signal generator 106 according to the assignment result that indicates the determined assignment CCs. The assignment CC determiner 102 outputs, to the local signal generator 106, a control signal that indicates a frequency band that matches the assignment result to control the frequency of a local signal generated by the local signal generator 106. Thus, a transmission frequency band in the up-converter 107 and a reception frequency band in the down-converter 109 are controlled according to the assignment result. The assignment CC determiner 102 outputs the assignment result to the coder-modulator 103. Processing executed by the assignment CC determiner 102 will be described later in detail.

The coder-modulator 103 codes the transmission data and assignment result, modulates the coded data, and then outputs the modulated data to the IFFT 104.

The IFFT 104 performs IFFT processing on the modulated data to generate an orthogonal frequency division multiplexing (OFDM) signal, and outputs the generated OFDM signal to the D/A converter 105.

The D/A converter 105 converts the OFDM signal, which is a digital signal, to an analog OFDM signal and outputs the converted OFDM signal to the up-converter 107.

The local signal generator 106 generates a local signal at the frequency indicated by the control signal received from the assignment CC determiner 102 and outputs the generated local signal to the up-converter 107 and down-converter 109. Upon receipt of the assignment result, the local signal generator 106 generates a local signal with a prescribed frequency and outputs the generated local signal to the up-converter 107.

The up-converter 107 mixes the OFDM signal received from the D/A converter 105 and the local signal received from the local signal generator 106 to up-convert the frequency of the OFDM signal, and outputs the OFDM signal with the up-converted frequency to the mobile station through the antenna 108.

The assignment result is sent to the mobile station before data assigned to individual CCs is output thereto.

The down-converter 109 receives an OFDM signal sent from the mobile station through the antenna 108, mixes the received OFDM signal and the local signal received from the local signal generator 106 to down-convert the frequency of the OFDM signal, and outputs the OFDM signal with the down-converted signal to the A/D converter 110.

The A/D converter 110 converts the OFDM signal, which is an analog signal, to a digital OFDM signal and outputs the converted OFDM signal to the FFT 111.

The FFT 111 performs FFT processing on the A/D-converted OFDM signal and outputs the OFDM signal resulting from the FFT processing to the demodulator-decoder 112.

The demodulator-decoder 112 demodulates the signal resulting from the FFT processing and decodes the resulting signal to obtain reception data.

A cyclic prefix (CP) may be added to the OFDM signal. In this case, the CP is added at the output stage of the IFFT 104 and the CP is removed at the input stage of the FFT 111.

Processing Executed by the Assignment CC Determiner 102

The higher the priority of data is, the more reliably the data is expected to arrive at the mobile station. Data with a low priority often causes less adverse effect even if the data does not arrive at the mobile station. However, if data with a high priority is lost during a transfer, a significant adverse effect is often caused in a drop in throughput. That is, when data with a high priority is reliably sent to the mobile station, improvement in throughput can be expected; the higher the priority of data is, the more the data contributes to improvement in the throughput. In the first embodiment, therefore, data with a high priority is assigned to CCs included in a low frequency band having superior propagation properties.

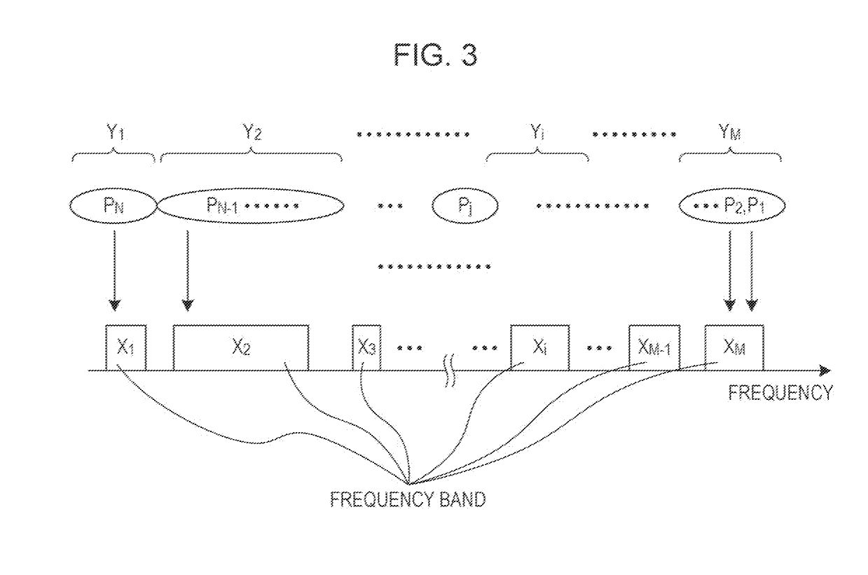

FIG. 3 illustrates processing executed by the assignment CC determiner 102 in the first embodiment.

The number of CCs included in each of the plurality of frequency bands that the base station 10 can use is assumed to be Xᵢ (i is an integer from 1 to M). The LCH priority of each transmission data item is assumed to be Pⱼ (j is an integer from 1 to N); P_{N} is assumed to be the maximum LCH priority.

The assignment CC determiner 102 assigns LCH priority Pⱼ to each frequency band according to the ratio of the number Xᵢ of CCs included in a particular frequency band to the number of CCs included in all frequency bands.

First, the assignment CC determiner 102 obtains the number Yᵢ of LCH priorities to be assigned to the particular frequency band according to equation (1) below. If Yᵢ becomes a decimal number, the assignment CC determiner 102 rounds off Yᵢ to the nearest integer.

$${Y}_{i} = ( {X}_{i} / {\sum }_{i = 1}^{M} {X}_{i} ) \times N \qquad ( 1 )$$

After having obtained the number Yᵢ of LCH priorities from equation (1), the assignment CC determiner 102 sequentially assigns LCH priorities Pⱼ ranging from the maximum LCH priority P_{N} to the minimum LCH priority P₁ to M frequency bands that the base station 10 can use, starting from the lowest frequency band that is assigned the maximum LCH priority P_{N}. If as illustrated in FIG. 3, a first frequency band of the M frequency bands includes X₁ CCs, a second frequency band includes X₂ CCs, a third frequency band includes X₃ CCs, . . . , and the Mth frequency band includes X_{M} CCs, then Yᵢ LCH priorities of a total number of LCH priorities from Y₁ LCH priorities to Y_{M} LCH priorities are assigned to the frequency band in which Xᵢ CCs are included.

The assignment CC determiner 102 determines assignment CCs according to the above assignment and to the LCH priority of the transmission data.

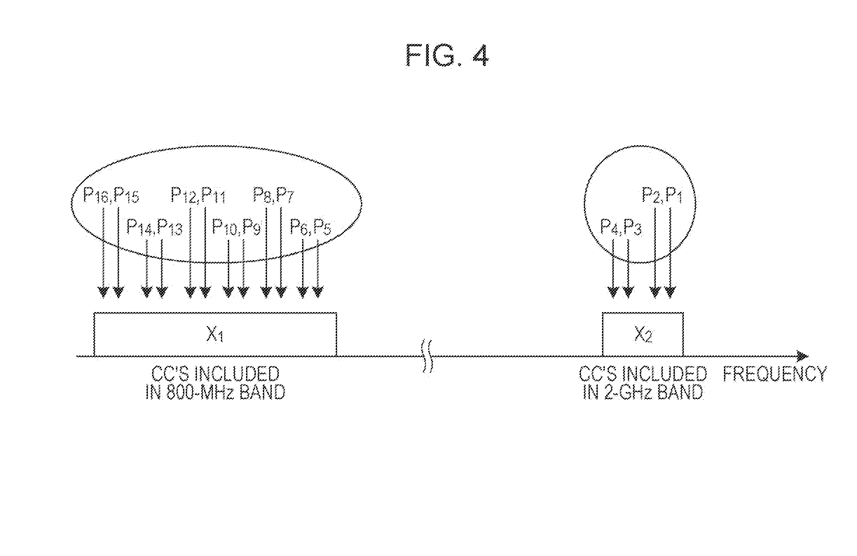

A specific example will be described below. FIG. 4 illustrates a specific example of assignment in the first embodiment.

The base station 10 is assumed to be capable of using two frequency bands, 800-MHz band and 2-GHz band. It is also assumed that the number X₁ of CCs included in the 800-MHz band is 6 and the number X₂ of CCs included in the 2-GHz band is 2. It is also assumed that 16 LCH priorities P₁ to P₁₆ can be set for transmission data; P₁₆, is the maximum LCH priority. That is, transmission data for which P₁₆ has been set has the highest priority, and transmission data for which P₁ has been set has the lowest priority. In equation (1), therefore, M is 2 and N is 16. Then, the assignment CC determiner 102 obtains Yᵢ (i=1, 2) by using equation (1) as follows.

$${X}_{1} = 6 , {X}_{2} = 2$$

$${\sum }_{i = 1}^{2} {X}_{i} = {X}_{1} + {X}_{2} = 6 + 2 = 8$$

$$therefore$$

$${Y}_{1} = ( {X}_{1} / {\sum }_{i = 1}^{2} {X}_{i} ) \times 16 = ( 6 / 8 ) \times 16 = 12$$

$${Y}_{2} = ( {X}_{2} / {\sum }_{i = 1}^{2} {X}_{i} ) \times 16 = ( 2 / 8 ) \times 16 = 4$$

Accordingly, the assignment CC determiner 102 assigns each of transmission data items, for each of which an LCH priority from P₅ to P₁₆, has been set, that is, transmission data items having a high priority, to any one of the six CCs included in the low 800-MHz band, as illustrated in FIG. 4. Similarly, the assignment CC determiner 102 assigns each of transmission data items, for each of which an LCH priority from P₁ to P₄, has been set, that is, transmission data items having a low priority, to any one of the two CCs included in the high 2-GHz band, as illustrated in FIG. 4.

Operation of the Base Station 10

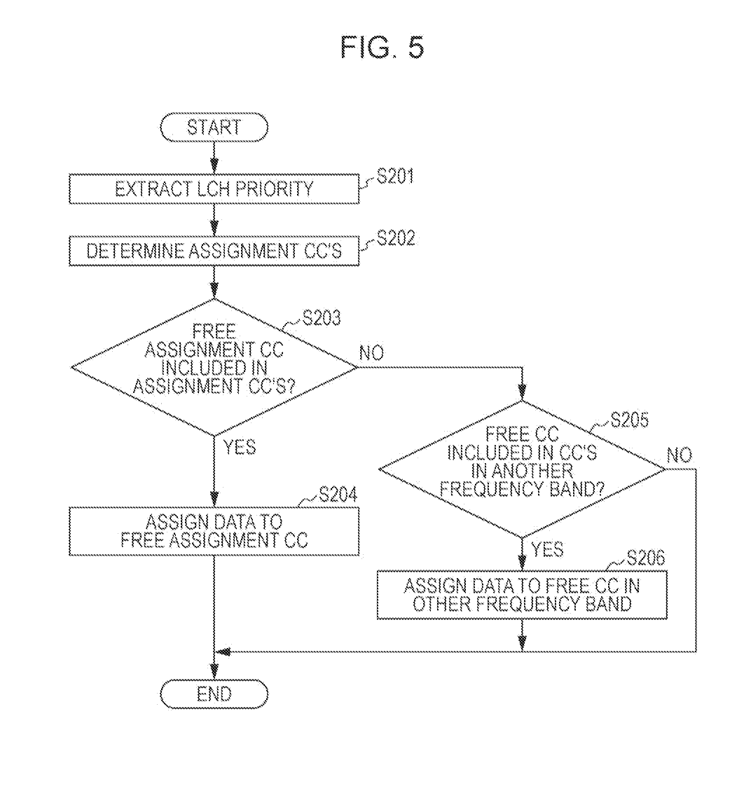

FIG. 5 is a flowchart that illustrates operation performed by the base station 10 in the first embodiment. A series of processing illustrated in FIG. 5 is executed once for each transmission data item for one sub-frame.

First, the LCH priority extractor 101 extracts the LCH priority added to the transmission data (step S201).

Then, the assignment CC determiner 102 determines assignment CCs according to the priority of the transmission data as described in “Processing executed by the assignment CC determiner 102” (step S202).

The assignment CC determiner 102 then checks whether there is a free CC in the assignment CCs determined in step S202 (step S203). If there is a free CC (the result in step S203 is Yes), the assignment CC determiner 102 assigns transmission data to the free CC and terminates the processing (step S204).

If there is no free CC in the assignment CCs determined in step S202 (the result in step S203 is No), the assignment CC determiner 102 determines whether there is a free CC in CCs in another frequency band (step S205).

If there is a free CC in CCs in the other frequency band (the result in step S205 is Yes), the assignment CC determiner 102 assigns transmission data to the free CC and terminates the processing (step S206). The assignment CC determiner 102 preferably assigns the transmission data to a CC with frequencies closer to the frequencies of the assignment CCs determined in step S202.

If there is no free CC in CCs in the other frequency band (the result in step S205 is No), the assignment CC determiner 102 suspends the assignment of transmission data to a CC and terminates the processing.

As described above, in the base station 10, in the first embodiment, that can communicate by using any of a plurality of frequency bands, each of which includes a plurality of CCs, the assignment CC determiner 102 assigns data with a high priority to CCs included in a low frequency band and assigns data with a low priority to CCs included in a high frequency band.

Thus, data with a higher priority is assigned to a frequency band having more superior propagation properties, so the throughput can be improved.

### Second Embodiment

In this embodiment, assignment CCs are determined according to the maximum data transfer rate.

Structure of a Base Station 30

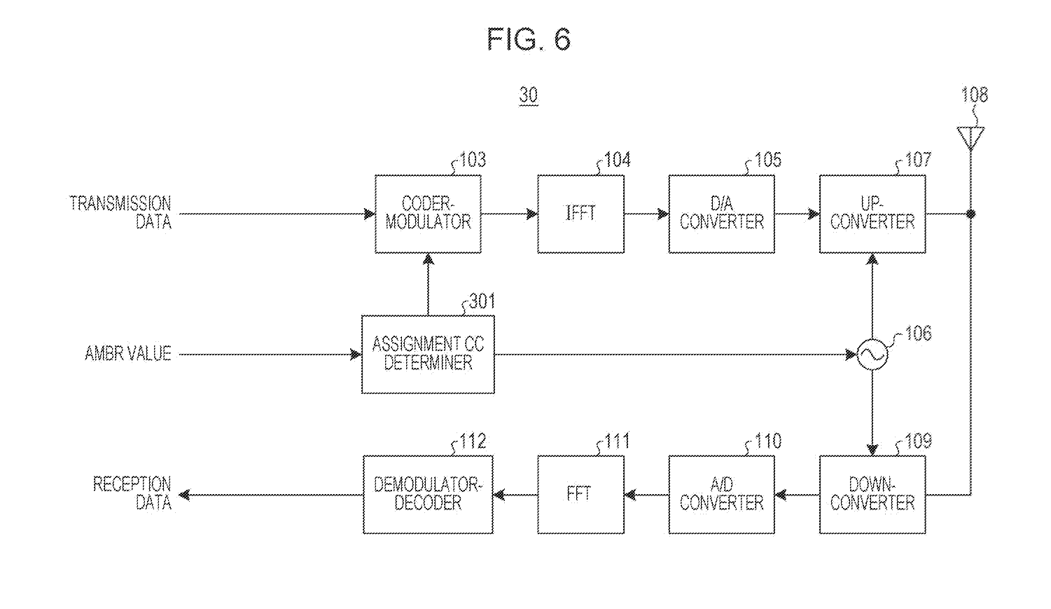

FIG. 6 is a block diagram that illustrates an example of the structure of the base station 30 in the second embodiment. The base station 30 in FIG. 6 includes an assignment CC determiner 301, a coder-modulator 103, an IFFT 104, a D/A converter 105, a local signal generator 106, an up-converter 107, an antenna 108, a down-converter 109, an A/D converter 110, an FFT 111, and a demodulator-decoder 112.

The assignment CC determiner 301 receives the value of an aggregate maximum bit rate (AMBR) included in transmission data. The AMBR value is set in the transmission data by a mobility management entity (MME). The AMBR value, which indicates the maximum transfer rate of transmission data, is set for each transmission data item according to, for example, its importance, urgency, nature of real time, QoS, or total amount of data.

The assignment CC determiner 301 determines assignment CCs according to the entered AMBR value, and controls the frequency of the local signal generator 106 according to the assignment result. The assignment CC determiner 301 outputs, to the local signal generator 106, a control signal that indicates a frequency band that matches the assignment result to control the frequency of a local signal to be generated by the local signal generator 106. Thus, a transmission frequency band in the up-converter 107 and a reception frequency band in the down-converter 109 are controlled according to the assignment result. The assignment CC determiner 301 outputs the assignment result to the coder-modulator 103. Processing executed by the assignment CC determiner 301 will be described below in detail.

Processing Executed by the Assignment CC Determiner 301

If data having a high AMBR value is lost during a transfer, a significant adverse effect is often caused in a drop in throughput. That is, when data with a higher AMBR value is more reliably sent to the mobile station, improvement in throughput can be expected; the higher the AMBR value is, the more the data contributes to improvement in the throughput. In the second embodiment, therefore, data with a high AMBR value is assigned to CCs included in a low frequency band having superior propagation properties.

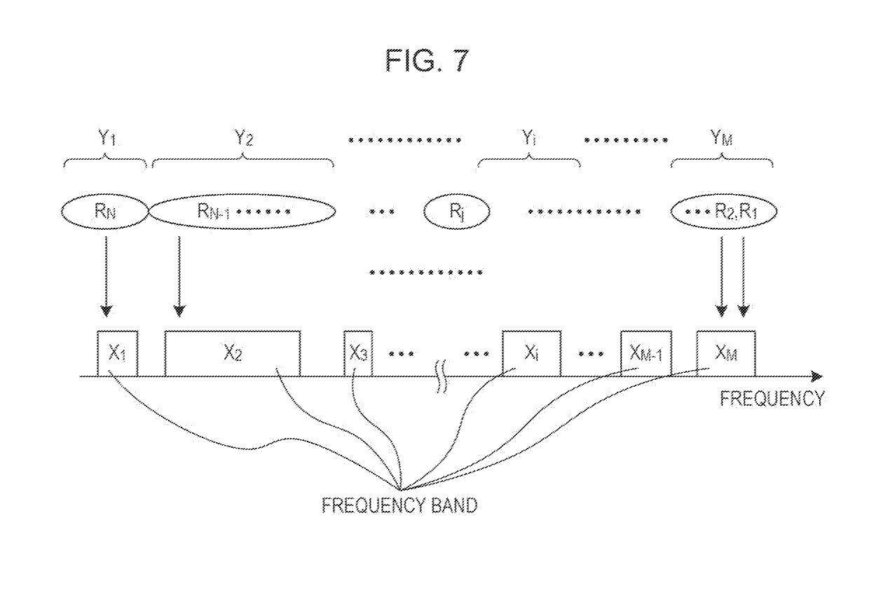

FIG. 7 illustrates processing executed by the assignment CC determiner 301 in the second embodiment.

The number of CCs included in each of the plurality of frequency bands that the base station 30 can use is assumed to be Xᵢ (i is an integer from 1 to M), The AMBR value of each transmission data item is assumed to be AR_{S}. It is also assumed that the maximum settable AMBR value is ARₘₐₓ and a range obtained by dividing ARₘₐₓ by an integer N is AMBR range Rⱼ (j is an integer from 1 to N).

The assignment CC determiner 301 determines AMBR range Rᵢ in which the AMBR value ARs of the transmission data is included, as indicated by equation (2) below.

$$\begin{matrix}\begin{matrix}\begin{matrix}\begin{matrix}\begin{matrix}0 \leq {AR}_{s} < ( {AR}_{m ax} / N ) If {R}_{1} \\ ( {AR}_{m ax} / N ) \leq {AR}_{s} < 2 ( {AR}_{m ax} / N ) If {R}_{2}\end{matrix} \\ 2 ( {AR}_{ma x} / N ) \leq {AR}_{s} < 3 ( {AR}_{m ax} / N ) If {R}_{3}\end{matrix} \\ ⋮\end{matrix} \\ ( N - 2 ) \times ( {AR}_{m ax} / N ) \leq {AR}_{s} < ( N - 1 ) \times ( {AR}_{m ax} / N ) If {R}_{N - 1}\end{matrix} \\ ( N - 1 ) \times ( {AR}_{m ax} / N ) \leq {AR}_{s} < {AR}_{m ax} If {R}_{N}\end{matrix} \} \qquad ( 2 )$$

If it is assumed that ARₘₐₓ is 1.6 Mbps, N is 16, and AR_{S} is 250 kbps, for example, the value obtained by dividing ARₘₐₓ by N is 100 kbps, indicating that AR_{S} is greater than or equal to 200 kbps and smaller than 300 kpbs. Therefore, it is determined that an AR_{S} of 250 kpbs is included in range R₃.

Next, the assignment CC determiner 301 assigns AMBR range R₃ to each frequency band according to the ratio of the number Xᵢ of CCs included in a particular frequency band to the number of CCs included in all frequency bands.

First, the assignment CC determiner 301 obtains the number Yᵢ of AMBR ranges to be assigned to the particular frequency band according to equation (1) described above. If Yᵢ becomes a decimal number, the assignment CC determiner 301 rounds off Yᵢ to the nearest integer.

After having obtained the number Yᵢ of AMBR ranges from equation (1), the assignment CC determiner 301 sequentially assigns AMBR ranges Rⱼ ranging from the maximum value R_{N} in all the AMBR ranges to the minimum value R₁ in all the AMBR ranges to M frequency bands that the base station 30 can use, starting from the lowest frequency band that is assigned the AMBR range including the maximum value R_{N}. If as illustrated in FIG. 7, a first frequency band of the M frequency bands includes X₁ CCs, a second frequency band includes X₂ CCs, a third frequency band includes X₃ CCs, . . . , and the Mth frequency band includes X_{M} CCs, then Yᵢ AMBR ranges of a total number of AMBR ranges from Y₁ AMBR ranges to Y_{M} AMBR ranges are assigned to the frequency band in which Xᵢ CCs are included.

The assignment CC determiner 301 determines assignment CCs according to the above assignment and to the AMBR value of the transmission data.

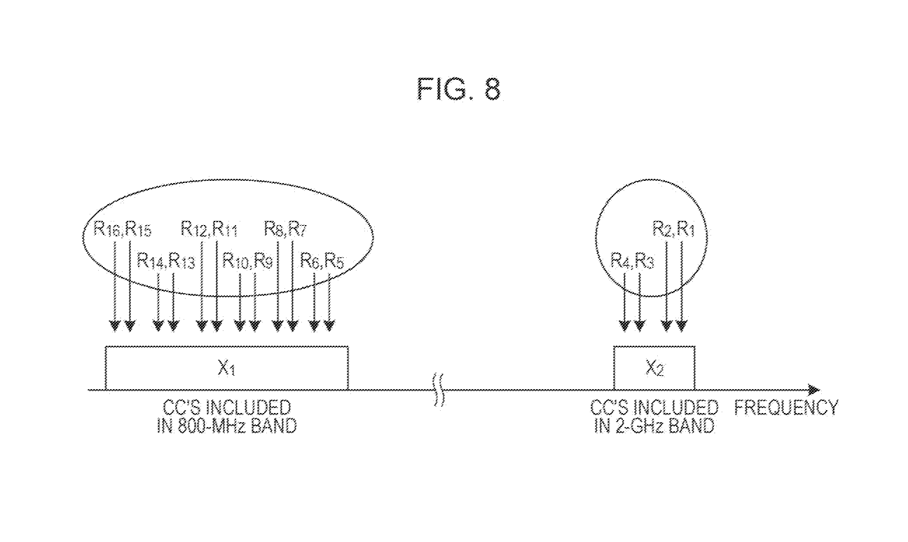

A specific example will be described below. FIG. 8 illustrates a specific example of assignment in the second embodiment.

The base station 30 is assumed to be capable of using two frequency bands, 800-MHz band and 2-GHz band. It is also assumed that the number X₁ of CCs included in the 800-MHz band is 6 and the number X₂ of CCs included in the 2-GHz band is 2. It is also assumed that there are 16 AMBR ranges from R₁ to R₁₆; R₁₆ is maximum in all the AMBR ranges. That is, the AMBR value included in R₁₆ is largest and the AMBR value included in R₁ is smallest. The maximum value ARₘₐₓ of the AMBR values is assumed to be 1.6 Mbps.

The assignment CC determiner 301 determines each Rⱼ according to equation (2) as follows: R₁ is from 0 to less than 100 kbps, R₂ is from 100 to less than 200 kbps, R₃ is from 200 to less than 300 kbps, R₄ is from 300 to less than 400 kbps, R₅ is from 400 to less than 500 kbps, R₆ is from 500 to less than 600 kbps, R₇ is from 600 to less than 700 kbps, R₈ is from 700 to less than 800 kbps, R₉ is from 800 to less than 900 kbps, R₁₀ is from 900 to less than 1000 kbps, R₁₁ is from 1.0 to less than 1.1 Mbps, R₁₂ is from 1.1 to less than 1.2 Mbps, R₁₃ is from 1.2 to less than 1.3 Mbps, R₁₄ is from 1.3 to less than 1.4 Mbps, R₁₅ is from 1.4 to less than 1.5 Mbps, and R₁₆ is from 1.5 to less than 1.6 Mbps.

In equation (1) above, therefore, M is 2 and N is 16. The assignment CC determiner 301 then obtains 12 as Y₁ and 4 as Y₂ from equation (1), as in the first embodiment.

Accordingly, the assignment CC determiner 301 assigns each of transmission data items, for each of which an AMBR value included in any one of AMBR ranges R₅ to R₁₆ has been set, that is, transmission data items having high a maximum transfer rate, to any one of the six CCs included in the low 800-MHz band, as illustrated in FIG. 8. Similarly, the assignment CC determiner 301 assigns each of transmission data items, for each of which an AMBR value included in any one of AMBR ranges R₁ to R₄ has been set, that is, transmission data items having a low maximum transfer rate, to any one of the two CCs included in the high 2-GHz band, as illustrated in FIG. 8. Accordingly, for example, transmission data for which ARs is set to 250 kbps is assigned to a CC in the 2-GHz band.

Operation of the Base Station 30

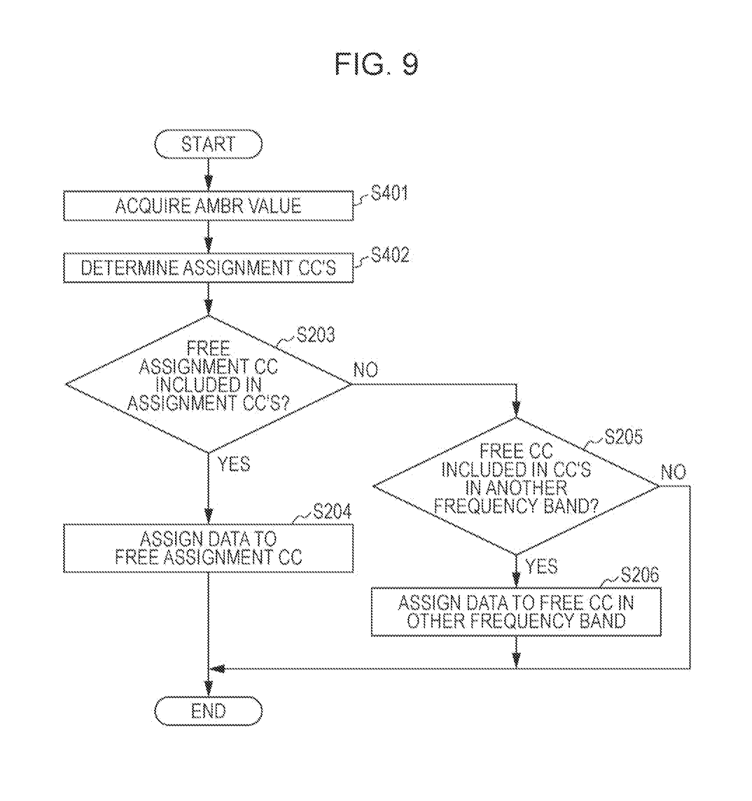

FIG. 9 is a flowchart that illustrates operation performed by the base station 30 in the second embodiment. A series of processing illustrated in FIG. 9 is executed once for each transmission data item for one sub-frame.

First, the assignment CC determiner 301 acquires an entered AMBR value (step S401).

The assignment CC determiner 301 then determines assignment CCs according to the AMBR value of the transmission data as described in “Processing executed by the assignment CC determiner 301” (step S402).

As described above, in the base station 30, in the second embodiment, that can communicate by using any of a plurality of frequency bands, each of which includes a plurality of CCs, the assignment CC determiner 301 assigns data with a high maximum transfer rate to CCs included in a low frequency band, and assigns data with a low maximum transfer rate to CCs included in a high frequency band.

Thus, data with a higher maximum transfer rate is assigned to a frequency band having more superior propagation properties, so the throughput can be improved.

### Third Embodiment

In this embodiment, assignment CCs are determined according to the distance between the base station and a mobile station to which to send data.

Structure of a Base Station 50

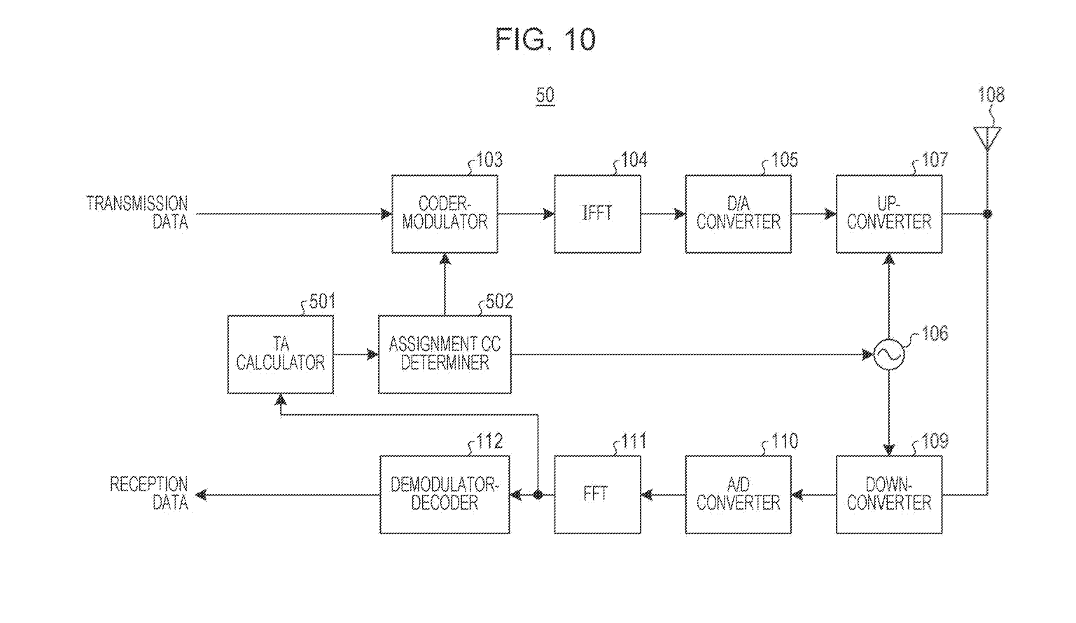

FIG. 10 is a block diagram that illustrates an example of the structure of the base station 50 in the third embodiment. The base station 50 in FIG. 10 includes a coder-modulator 103, an IFFT 104, a D/A converter 105, a local signal generator 106, an up-converter 107, an antenna 108, a down-converter 109, an A/D converter 110, an FFT 111, a demodulator-decoder 112, a timing advance (TA) calculator 501, and an assignment CC determiner 502.

The TA calculator 501 receives a signal from the FFT 111, the signal having undergone FFT processing. The TA calculator 501 then calculates a TA for each mobile station that is within a communication area supported by the base station 50 and can communicate with the base station 50, from a timing at which a signal was received from the mobile station, after which the TA calculator 501 outputs the calculated TA to the assignment CC determiner 502.

The TA is used to adjust a transmission timing at each mobile station according to the distance between the mobile station and the base station 50 so that signals sent from different mobile stations are received at the base station 50 at the same timing. The longer the distance between the base station 50 and the mobile station, the earlier the mobile station desirably starts transmission, so a larger TA is calculated for a mobile station at a longer distance from the base station 50. Accordingly the TA indicates the distance between the base station 50 and the mobile station. To calculate the TA, the TA calculator 501 is provided in a conventional base station as well.

The assignment CC determiner 502 determines assignment CCs according to the TA value received from the TA calculator 501 and controls the frequency of the local signal generator 106 according to the assignment result. The assignment CC determiner 502 outputs, to the local signal generator 106, a control signal that indicates a frequency band that matches the assignment result to control the frequency of a local signal to be generated by the local signal generator 106. Thus, a transmission frequency band in the up-converter 107 and a reception frequency band in the down-converter 109 are controlled according to the assignment result. The assignment CC determiner 502 outputs the assignment result to the coder-modulator 103. Processing executed by the assignment CC determiner 502 will be described below in detail.

Processing Executed by the Assignment CC Determiner 502

In an environment in which there is an obstacle, radio signals in low-frequency bands are more likely arrive at a long distance point than in high-frequency bands. Even if data has a high frequency, the data arrives at a mobile station at a short distance from the base station 50. In the third embodiment, therefore, data to be sent to a mobile station having a large TA value, that is, at a long distance from the base station 50, is assigned to CCs included in a low frequency band.

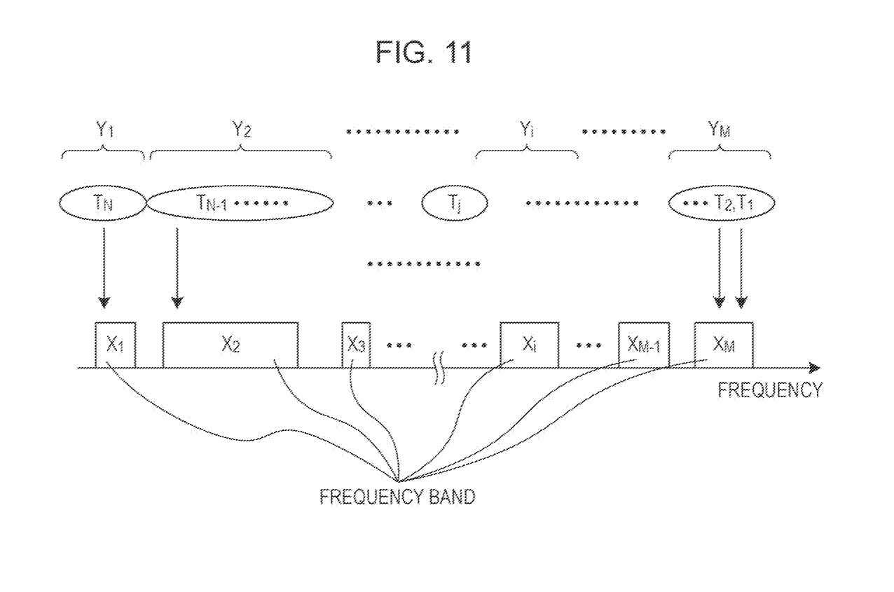

FIG. 11 illustrates processing executed by the assignment CC determiner 502 in the third embodiment.

The number of CCs included in each of the plurality of frequency bands that the base station 50 can use is assumed to be Xᵢ (i is an integer from 1 to M). The TA value of each mobile station is assumed to be TA_{C}. It is also assumed that the maximum calculatable TA value is TAₘₐₓ and each range obtained by dividing TAₘₐₓ by an integer N is TA range Tⱼ (j is an integer from 1 to N).

The assignment CC determiner 502 determines TA range Tⱼ in which the TA value TA_{C} of each mobile station is included as indicated by equation (3) below.

$$\begin{matrix}\begin{matrix}\begin{matrix}\begin{matrix}\begin{matrix}0 \leq {TA}_{c} < ( {TA}_{m ax} / N ) If {T}_{1} \\ ( {TA}_{m ax} / N ) \leq {TA}_{c} < 2 ( {TA}_{m ax} / N ) If {T}_{2}\end{matrix} \\ 2 ( {TA}_{m ax} / N ) \leq {TA}_{c} < 3 ( {TA}_{m ax} / N ) If {T}_{3}\end{matrix} \\ ⋮\end{matrix} \\ ( N - 2 ) \times ( {TA}_{m ax} / N ) \leq {TA}_{c} < ( N - 1 ) \times ( {TA}_{m ax} / N ) If {T}_{N - 1}\end{matrix} \\ ( N - 1 ) \times ( {TA}_{m ax} / N ) \leq {TA}_{c} < {TA}_{ma x} If {T}_{N}\end{matrix} \} \qquad ( 3 )$$

If it is assumed that TAₘₐₓ is 160 μs, N is 16, and TA_{C} is 25 μs, for example, the value obtained by dividing TAₘₐₓ by N is 10 μs, indicating that TA_{C} is greater than or equal to 20 μs and smaller than 30 μs. Therefore, it is determined that a TA_{C} of 25 μs is included in range T₃.

Next, the assignment CC determiner 502 assigns TA range T_{T} to each frequency band according to the ratio of the number Xᵢ of CCs included in a particular frequency band to the number of CCs included in all frequency bands.

First, the assignment CC determiner 502 obtains the number Yᵢ of TA ranges to be assigned to the particular frequency band according to equation (1) described above. If Yᵢ becomes a decimal number, the assignment CC determiner 502 rounds off Yᵢ to the nearest integer.

After having obtained the number Yᵢ of TA ranges from equation (1), the assignment CC determiner 502 sequentially assigns TA ranges T_{T} ranging from the maximum value T_{N} in all the TA ranges to the minimum value T₁ in all the TA range to M frequency bands that the base station 50 can use, starting from the lowest frequency band that is assigned the TA range including the maximum value T_{N}. If as illustrated in FIG. 11, a first frequency band of the M frequency bands includes X₁ CCs, a second frequency band includes X₂ CCs, a third frequency band includes X₃ CCs, . . . , and the Mth frequency band includes X_{M} CCs, then Yᵢ TA ranges of a total number of TA ranges from Y₁ TA ranges to Y_{M} TA ranges are assigned to the frequency band in which Xᵢ CCs are included.

The assignment CC determiner 502 determines assignment CCs according to the above assignment and to the TA value of the transmission data.

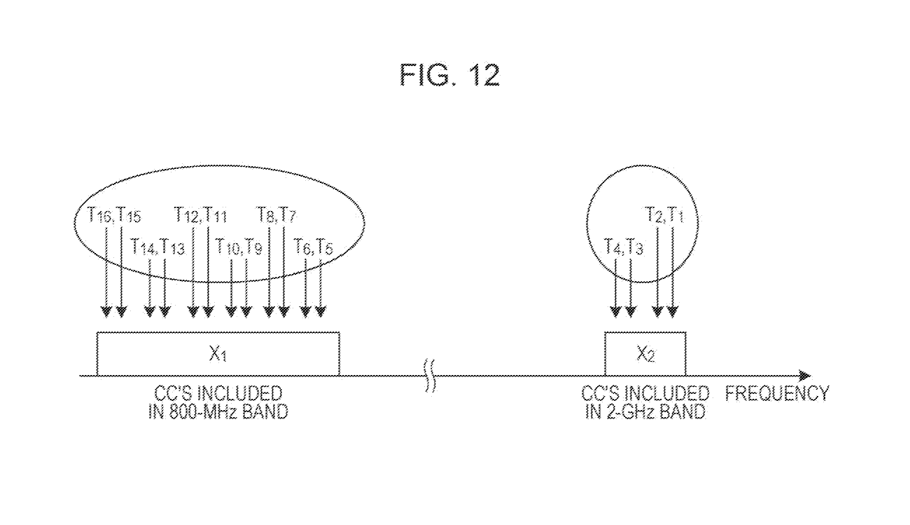

A specific example will be described below. FIG. 12 illustrates a specific example of assignment in the third embodiment.

The base station 50 is assumed to be capable of using two frequency bands, 800-MHz band and 2-GHz band. It is also assumed that the number X₁ of CCs included in the 800-MHz band is 6 and the number X₂ of CCs included in the 2-GHz band is 2. It is also assumed that there are 16 TA ranges from T₁ to T₁₆; T₁₆ is maximum in all the TA ranges. That is, the TA value included in T₁₆ is largest and the TA value included in T₁ is smallest.

The assignment CC determiner 502 determines each Tⱼ according to equation (3) as follows: T₁ is from 0 to less than 10 μs, T₂ is from 10 to less than 20 μs, T₃ is from 20 to less than 30 μs, T₄ is from 30 to less than 40 μs, T₅ is from 40 to less than 50 μs, T₆ is from 50 to less than 60 μs, T₇ is from 60 to less than 70 μs, T₈ is from 70 to less than 80 μs, T₉ is from 80 to less than 90 μs, T₁₀ is from 90 to less than 100 μs, T₁₁ is from 100 to less than 110 μs, T₁₂ is from 110 to less than 120 μs, T₁₃ is from 120 to less than 130 μs, T₁₄ is from 130 to less than 140 μs, T₁₅ is from 140 to less than 150 μs, and T₁₆ is from 150 to less than 160 μs.

In equation (1) above, therefore, M is 2 and N is 16. The assignment CC determiner 502 then obtains 12 as Y₁ and 4 as Y₂ from equation (1), as in the first embodiment.

Accordingly, the assignment CC determiner 502 assigns each of transmission data items, each of which is to be sent to a mobile station having a TA value included in any one of TA ranges T₅ to T₁₆, that is, transmission data items to be sent to mobile stations at long distances from the base station 50, to any one of the six CCs included in the low 800-MHz band, as illustrated in FIG. 12. Similarly, the assignment CC determiner 502 assigns each of transmission data items, each of which is to be sent to a mobile station having a TA value included in any one of TA ranges T₁ to T₄, that is, transmission data items to be set to mobile stations at short distances from the base station 50, to any one of the two CCs included in the high 2-GHz band, as illustrated in FIG. 12. Accordingly, for example, transmission data to be sent to a mobile station having a TA_{C} value of 25 μs is assigned to a CC in the 2-GHz band.

Operation of the Base Station 50

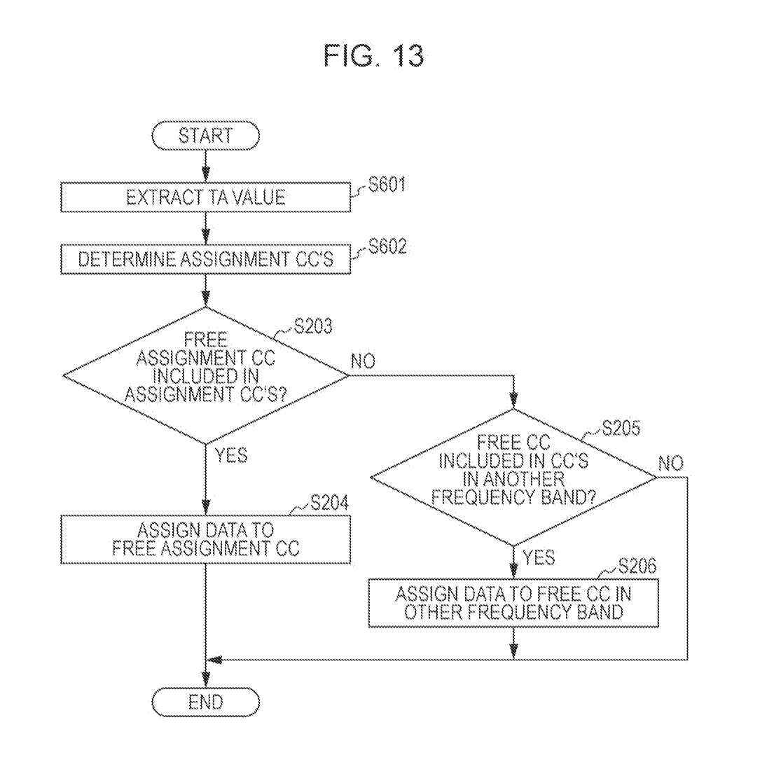

FIG. 13 is a flowchart that illustrates operation performed by the base station 50 in the third embodiment. A series of processing illustrated in FIG. 13 is executed once for each transmission data item for one sub-frame.

First, the TA calculator 501 extracts a mobile-station-specific TA value (step S601).

Then, the assignment CC determiner 502 determines assignment CCs according to the mobile-station-specific TA value as described in “Processing executed by the assignment CC determiner 502” (step S602).

As described above, in the base station 50, in the third embodiment, that can communicate by using any of a plurality of frequency bands, each of which includes a plurality of CCs, the assignment CC determiner 502 assigns data to be sent to a mobile station having a large TA value (that is, a mobile station at a long distance from the base station 50) to CCs included in a low frequency band, and assigns data to be sent to a mobile station having a small TA value (that is, a mobile station at a short distance from the base station 50) to CCs included in a high frequency band.

Thus, data to be sent to a mobile station at a longer distance from the base station 50 is assigned to a frequency band having more superior propagation properties, so the throughput can be improved.

### Fourth Embodiment

In this embodiment, assignment CCs are determined according to the number of tried receptions of a preamble signal sent from mobile stations through random access channels.

Structure of a Base Station 70

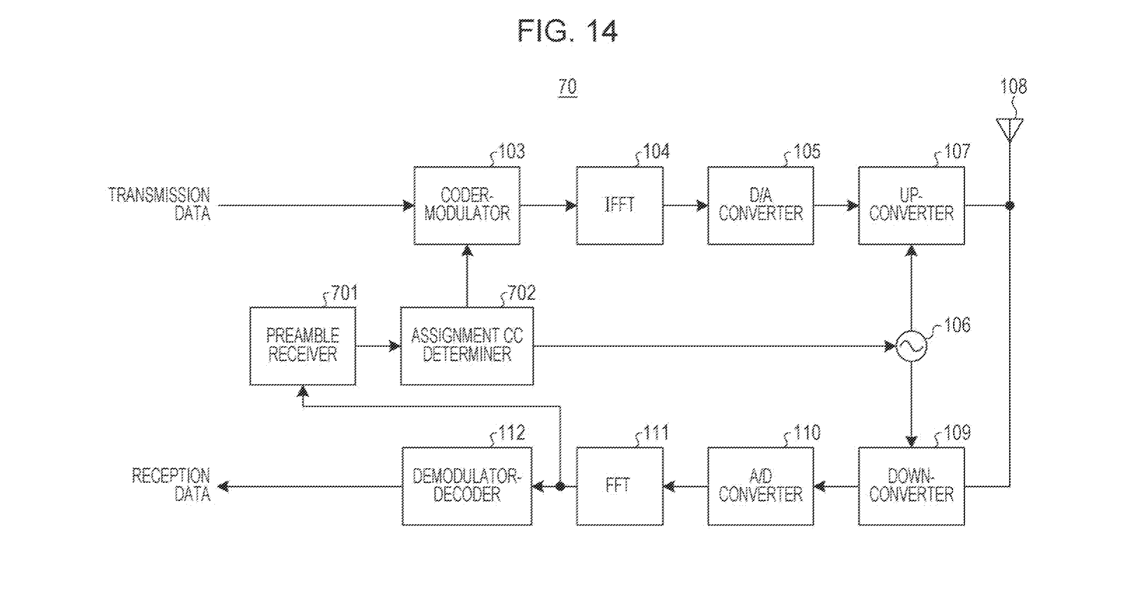

FIG. 14 is a block diagram that illustrates an example of the structure of the base station 70 in the fourth embodiment. The base station 70 in FIG. 14 includes a coder-modulator 103, an IFFT 104, a D/A converter 105, a local signal generator 106, an up-converter 107, an antenna 108, a down-converter 109, an A/D converter 110, an FFT 111, a demodulator-decoder 112, a preamble receiver 701, and an assignment CC determiner 702.

Of signals that have undergone FFT processing and supplied from the FFT 111, the preamble receiver 701 receives preamble signals that had been sent from mobile stations through random access channels (RACHs). The preamble receiver 701 repeatedly tries reception of preamble signals at intervals of a prescribed time until the preamble receiver 701 succeeds in receiving a preamble signal. The preamble receiver 701 counts the number of tried receptions of a preamble signal for each mobile station, and compares the counted number of tried receptions with a threshold Tₕ of the number of tried receptions. If the preamble receiver 701 succeeds in receiving a preamble signal before the number of tried receptions exceeds the threshold Tₕ (the number of tried receptions is smaller than or equal to the threshold Tₕ), the preamble receiver 701 outputs a notification of successful reception to the assignment CC determiner 702. If the number of tried receptions exceeds the threshold Tₕ, that is, reception of a preamble signal fails, the preamble receiver 701 outputs a notification of unsuccessful reception to the assignment CC determiner 702. When the preamble receiver 701 outputs the successful reception notification or unsuccessful reception notification, the number of tried receptions is reset to 0.

The RACH is a channel used for initial access from a mobile station to the base station 70. The mobile station uses the RACH at the time of initial access to the base station 70 to send, to the base station 70, a request for a connection to the base station 70 and a preamble signal that, for example, asks the base station 70 to assign a band. The mobile station randomly selects any one of a plurality of frequency bands that the base station 70 can use in communication with the mobile station and uses the RACH in the selected frequency band to send a preamble signal. In this case, the mobile station repeatedly sends preamble signals at intervals of a predetermined time while gradually increasing transmission electric power. A propagation environment for each of the plurality of frequency bands that the base station 70 can use in communication with the mobile station changes independently with time. Accordingly, if the propagation environment of the frequency band selected by the mobile station is superior at a time when a preamble signal is sent, the base station 70 succeeds in receiving the preamble signal before the number of tried receptions exceeds the threshold Tₕ. If the propagation environment of the frequency band selected by the mobile station is poor at a time when a preamble signal is sent, the number of tried receptions exceeds the threshold Tₕ and the base station 70 fails in receiving a preamble signal.

Thus, the assignment CC determiner 702 determines assignment CCs according to the notification received from the preamble receiver 701, and controls the frequency of the local signal generator 106 according to the assignment result. The assignment CC determiner 702 outputs, to the local signal generator 106, a control signal that indicates a frequency band that matches the assignment result to control the frequency of a local signal to be generated by the local signal generator 106. Thus, a transmission frequency band in the up-converter 107 and a reception frequency band in the down-converter 109 are controlled according to the assignment result. The assignment CC determiner 702 outputs the assignment result to the coder-modulator 103.

If the assignment CC determiner 702 receives a notification of successful reception from the preamble receiver 701, that is, the number of tried receptions is smaller than or equal to the threshold Tₕ, the assignment CC determiner 702 determines that the propagation environment of the frequency band selected by the mobile station is superior and assigns transmission data to CCs included in the frequency band identical to the frequency band that has been used to receive the preamble signal. If the assignment CC determiner 702 receives a notification of unsuccessful reception from the preamble receiver 701, that is, the number of tried receptions is greater than the threshold Tₕ, the assignment CC determiner 702 determines that the propagation environment of the frequency band selected by the mobile station is poor and assigns transmission data to CCs included in the frequency band different from the frequency band that has been used to receive the preamble signal.

For example, the base station 70 is assumed to be capable of using two frequency bands, 800-MHz band and 2-GHz band, and the mobile station is also assumed to have used the RACH in the 2-GHz band to send preamble signals. If the assignment CC determiner 702 receives a notification of successful reception from the preamble receiver 701, the assignment CC determiner 702 assigns transmission data to a CC in the 2-GHz band. If the assignment CC determiner 702 receives a notification of unsuccessful reception from the preamble receiver 701, the assignment CC determiner 702 assigns transmission data to a CC in the 800-MHz band.

Operation of the Base Station 70

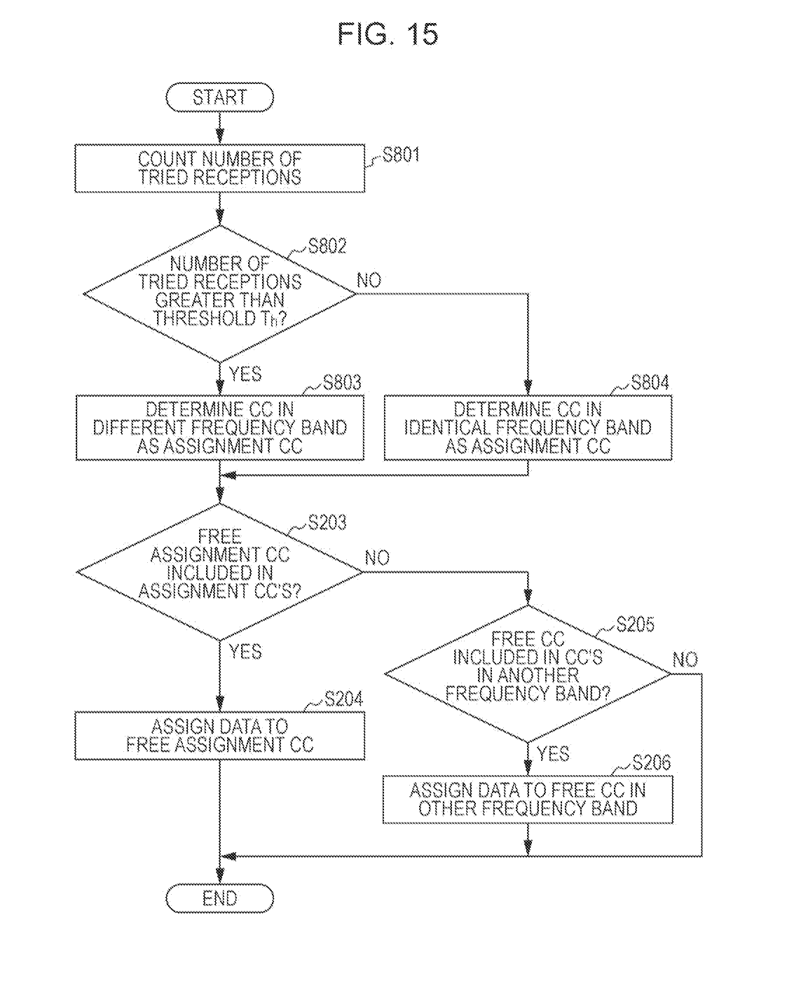

FIG. 15 is a flowchart that illustrates operation performed by the base station 70 in the fourth embodiment. A series of processing illustrated in FIG. 15 is executed once for each transmission data item for one sub-frame.

The preamble receiver 701 counts the number of tried receptions of a preamble signal and outputs a notification of successful reception or a notification of unsuccessful reception to the assignment CC determiner 702 (step S801).

If the assignment CC determiner 702 receives the unsuccessful reception notification from the preamble receiver 701, that is, the number of tried receptions is greater than the threshold Tₕ (the result in step S802 is Yes), the assignment CC determiner 702 determines, as an assignment CC, a CC in a frequency band different from the frequency band that has been used to receive the preamble signal (step S803).

If the assignment CC determiner 702 receives the successful reception notification from the preamble receiver 701, that is, the number of tried receptions is smaller than or equal to the threshold Tₕ (the result in step S802 is No), the assignment CC determiner 702 determines, as an assignment CC, a CC in a frequency band identical to the frequency band that has been used to receive the preamble signal (step S804).

As described above, in the base station 70, in the fourth embodiment, that can communicate by using any of a plurality of frequency bands, each of which includes a plurality of CCs, the assignment CC determiner 702 assigns data to a different CC depending on the number of tried receptions of a preamble signal; if the number of tried receptions is smaller than or equal to the threshold Tₕ, the assignment CC determiner 702 assigns the data to a CC in a frequency band identical to the frequency band that has been used to receive the preamble signal; if the number of tried receptions is greater than the threshold Tₕ, the assignment CC determiner 702 assigns the data to a CC in a frequency band different from the frequency band that has been used to receive the preamble signal.

Thus, it is suppressed that data is assigned to a CC in a frequency band the propagation environment of which is poor, so the throughput can be improved.

### Fifth Embodiment

In this embodiment, a mobile station 90 that can communicate with the base stations 10, 30, 50, and 70 in the first to fourth embodiment will be described. That is, the mobile station 90 can communicate with the base stations 10, 30, 50, and 70 by using any of a plurality of frequency bands, each of which includes a plurality of CCs. The mobile station 90 receives data assigned to any one of the plurality of CCs according to the priority of the data (in the first embodiment), to the AMBR value of the data (in the second embodiment), to the distance between the mobile station 90 and the base station 50 (in the third embodiment), or to the number or tried receptions of a preamble signal sent through the RACH (in the fourth embodiment), as well as an assignment result.

Structure of the Mobile Station 90

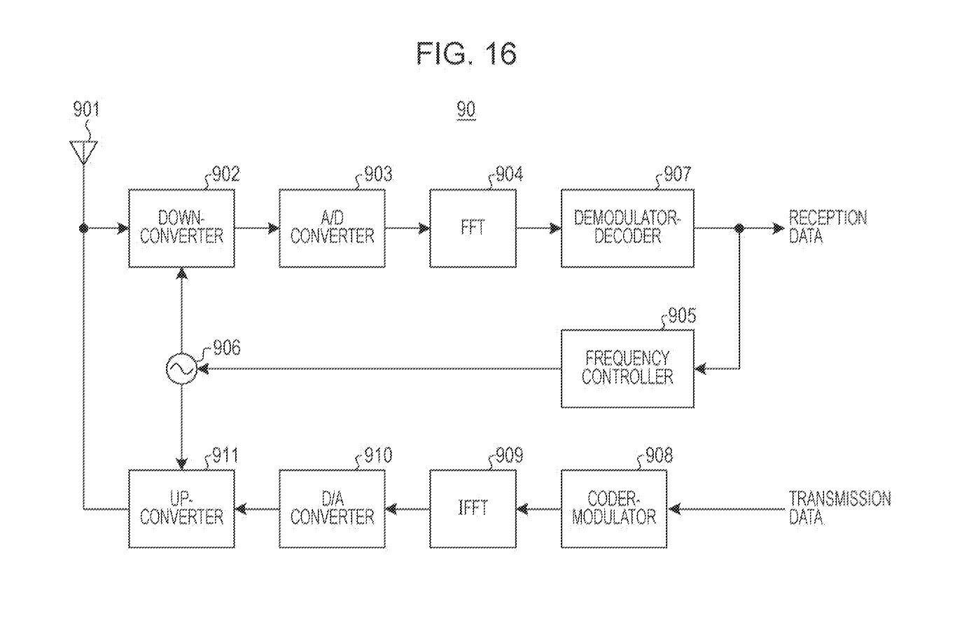

FIG. 16 is a block diagram that illustrates an example of the structure of the mobile station 90 in the fifth embodiment. The mobile station 90 in FIG. 16 includes an antenna 901, a down-converter 902, an analog-to-digital (A/D) converter 903, a fast Fourier transformer (FFT) 904, a frequency controller 905, a local signal generator 906, a demodulator-decoder 907, a coder-modulator 908, an inverse fast Fourier transformer (IFFT) 909, a digital-to-analog (D/A) converter 910, and an up-converter 911.

The down-converter 902 receives the OFDM signal sent from the base station 10, 30, 50, or 70 through the antenna 901, mixes the received OFDM signal and the local signal received from the local signal generator 906 to down-convert the frequency of the OFDM signal, and outputs the OFDM signal with the down-converted frequency to the A/D converter 903.

The A/D converter 903 converts the OFDM signal, which is an analog signal, to a digital OFDM signal and outputs the converted OFDM signal to the FFT 904.

The FFT 904 performs FFT processing on the A/D-converted OFDM signal and outputs the OFDM signal resulting from the FFT processing to the demodulator-decoder 907.

The demodulator-decoder 907 demodulates the signal resulting from the FFT processing and decodes the resulting signal to obtain reception data. The demodulator-decoder 907 then outputs the obtained reception data to the frequency controller 905. The reception data obtained in the demodulator-decoder 907 is an assignment result in the base station 10, 30, 50, or 70. Alternatively, the reception data is data that has been assigned by the base station 10, 30, 50, or 70 to a CC. The assignment result is received before data assigned to individual CCs is received.

The frequency controller 905 controls the frequency of the local signal generator 906 according to the assignment result. The frequency controller 905 outputs, to the local signal generator 906, a control signal that indicates a frequency band that matches the assignment result to control the frequency of a local signal to be generated by the local signal generator 906. Thus, a transmission frequency band in the down-converter 902 and a reception frequency band in the up-converter 911 are controlled according to the assignment result.

The local signal generator 906 generates a local signal at the frequency indicated by the control signal received from the frequency controller 905 and outputs the generated local signal to the down-converter 902 and up-converter 911. Upon receipt of the assignment result, the local signal generator 906 generates a local signal with a prescribed frequency and outputs the generated local signal to the down-converter 902.

The coder-modulator 908 codes the transmission data, modulates the coded data, and then outputs the modulated data to the IFFT 909.

The IFFT 909 performs IFFT processing on the modulated data to generate an OFDM signal, and outputs the generated OFDM signal to the D/A converter 910.

The D/A converter 910 converts the OFDM signal, which is a digital signal, to an analog OFDM signal and outputs the converted OFDM signal to the up-converter 911.

The up-converter 911 mixes the OFDM signal received from the D/A converter 910 and the local signal received from the local signal generator 906 to up-convert the frequency of the OFDM signal, and outputs the OFDM signal with the up-converted frequency to the base station 10, 30, 50, or 70 through the antenna 901.

A CP may be added to the OFDM signal. In this case, the CP is removed at the input stage of the FFT 904 and the CP is added at the output stage of the IFFT 909.

As described above, in the mobile station 90, in the fifth embodiment, that can communicate by using any of a plurality of frequency bands, each of which includes a plurality of CCs, the down-converter 902 receives data assigned to any one CC by the base station 10, 30, 50, or 70 as well as an assignment result. The frequency controller 905 controls the reception frequency band of the down-converter 902 in a plurality of frequencies with which communication is possible.

Thus, the mobile station 90 can receive data assigned to an optimum CC by the base station 10, 30, 50, or 70.

### Another Embodiment

Hardware structure of the base stations 10, 30, 50, and 70

The base stations 10, 30, 50, and 70 in the first to fourth embodiments can be implemented by a hardware structure as described below.

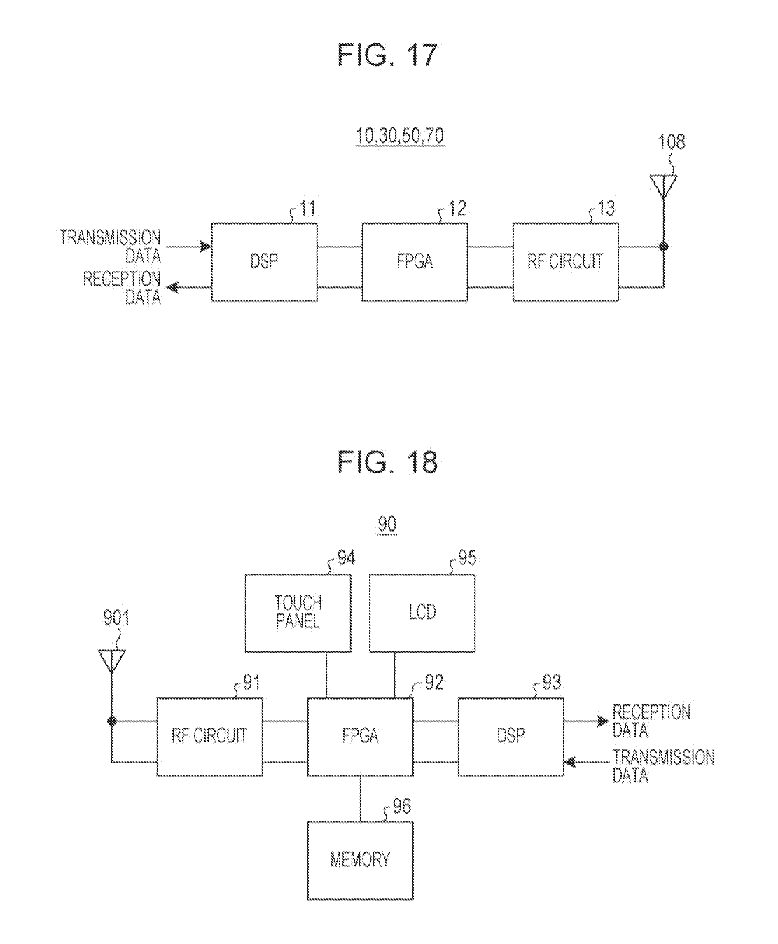

FIG. 17 illustrates an example of the hardware structure of the base stations 10, 30, 50, and 70. As illustrated in FIG. 17, the base stations 10, 30, 50, and 70 each include a digital signal processor (DSP) 11, a field-programmable gate array (FPGA) 12, a radio frequency (RF) circuit 13, and an antenna 108, as hardware components. The coder-modulator 103, demodulator-decoder 112, LCH priority extractor 101, TA calculator 501, preamble receiver 701, and assignment CC determiners 102, 301, 502 and 702 are implemented by the DSP 11. The IFFT 104 and FFT 111 are implemented by the FPGA 12. The D/A converter 105, A/D converter 110, up-converter 107, down-converter 109, and local signal generator 106 are implemented by the RF circuit 13.

Hardware Structure of the Mobile Station 90

The mobile station 90 in the fifth embodiment can be implemented by a hardware structure as described below.

FIG. 18 illustrates an example of the hardware structure of the mobile station 90. As illustrated in FIG. 18, the mobile station 90 includes an antenna 901, an RF circuit 91, an FPGA 92, a DSP 93, a touch panel 94, a liquid crystal display (LCD) 95, and a memory 96, as hardware components. The down-converter 902, up-converter 911, A/D converter 903, and D/A converter 910 are implemented by the RF circuit 91. The FFT 904 and IFFT 909 are implemented by the FPGA 92. The frequency controller 905, local signal generator 906, demodulator-decoder 907, and coder-modulator 908 are implemented by the DSP 93.

This completes the descriptions of the embodiments of the present disclosure.

In the embodiments described above, a case in which OFDM signals are sent and received has been described. However, signals to be sent and received are not limited to the OFDM signals. That is, in addition to multi-carrier signals, the technology disclosed above can be similarly applied to single-carrier signals. When the technology disclosed above is applied to single-carrier signals, the use of the IFFT 104 and FFT 111 can be excluded from FIGS. 2, 6, 10, and 14, and the use of the FFT 904 and IFFT 909 can be excluded from FIG. 16.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station apparatus operable to communicate by using any of a plurality of frequency bands, each of which includes a plurality of unit bands, the apparatus comprising:
a determiner that determines a unit band to which to assign data, according to a priority of the data, to a maximum data transfer rate of the data, to a distance between the base station apparatus and a mobile station apparatus to which to send the data, or to a number or tried receptions of a preamble signal that has been sent from the mobile station apparatus through a random access channel; and
a transmitter that sends the data by using the determined unit band.

2. The base station apparatus according to claim 1, wherein:
the plurality of frequency bands include a low-frequency band and a high-frequency band, the high-frequency band including a higher frequency than the low-frequency band;
the priority is one of a low priority and a high priority, the high priority being higher than the low priority; and
the determiner assigns data with the high priority to a unit band included in the low-frequency band and also assigns data with the low priority to a unit band included in the high-frequency band.

3. The base station apparatus according to claim 1, wherein:
the plurality of frequency bands include a low-frequency band and a high-frequency band, the high-frequency band including a higher frequency than the low-frequency band;
the maximum transfer rate is one of a low transfer rate and a high transfer rate, the high transfer rate being higher than the low transfer rate; and
the determiner assigns data with the high transfer rate to a unit band included in the low-frequency band and also assigns data with the low transfer rate to a unit band included in the high-frequency band.

4. The base station apparatus according to claim 1, wherein:
the plurality of frequency bands include a low-frequency band and a high-frequency band, the high-frequency band including a higher frequency than the low-frequency band;
the distance is one of a short distance and a long distance, the long distance being longer than the short distance; and
the determiner assigns data to be sent to a mobile station apparatus at the long distance to a unit band included in the low-frequency band and also assigns data at the short distance to a unit band included in the high-frequency band.

5. The base station apparatus according to claim 1, wherein:
if the number of tried receptions is smaller than or equal to a threshold, the determiner assigns the data to a unit band included in a frequency band identical to a frequency band that has been used to receive the preamble signal; and
if the number of tried receptions is greater than the threshold, the determiner assigns the data to a unit band included in a frequency band different from the frequency band that has been used to receive the preamble signal.

6. A mobile station apparatus operable to communicate by using any of a plurality of frequency bands, each of which includes a plurality of unit bands, the apparatus comprising:
a receiver that receives data that has been assigned to any one of the plurality of unit bands according to a priority of the data, to a maximum data transfer rate of the data, to a distance between the mobile station apparatus and a base station apparatus, or to a number or tried receptions of a preamble signal in a random access channel, the tried receptions having been carried out at the base station, and also receives an assignment result that indicates the unit band to which the data has been assigned; and
a controller that controls a reception frequency band of the receiver in the plurality of frequency bands according to the assignment result.

7. A wireless transmission method used at a base station apparatus operable to communicate by using any of a plurality of frequency bands, each of which includes a plurality of unit bands, the method comprising:
determining a unit band to which to assign data, according to a priority of the data, to a maximum data transfer rate of the data, to a distance between the base station apparatus and a mobile station apparatus to which to send the data, or to a number or tried receptions of a preamble signal that has been sent from the mobile station apparatus through a random access channel; and
sending the data by using the determined unit band.

8. A wireless reception method used at a mobile station apparatus operable to communicate by using any of a plurality of frequency bands, each of which includes a plurality of unit bands, the method comprising:
receiving an assignment result that indicates a unit band of the plurality of unit bands, data having been assigned to the unit band,
controlling a reception frequency band in the plurality of frequency bands according to the assignment result; and
receiving data that has been assigned to any one of the plurality of unit bands according to a priority of the data, to a maximum data transfer rate of the data, to a distance between the mobile station apparatus and a base station apparatus, or to a number or tried receptions of a preamble signal in a random access channel, the tried receptions having been carried out at the base station, according to the reception frequency band that has been controlled according to the assignment result.
